(19) United States
(12) Patent Application Publication
(10) Pub. No.: US 2009/0234734 A1
(43) Pub. Date: Sep. 17, 2009

(54) BIDDING ON RELATED KEYWORDS

(75) Inventors: Sreenivas Gollapudi, Cupertino, CA (US); Frank McSherry, San Francisco, CA (US); Rina Panigrahy, Sunnyvale, CA (US); Kunal Talwar, San Francisco, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/049,384

(22) Filed: Mar. 17, 2008

(51) Int. Cl. G06Q 30/00; G06F 7/06

(52) U.S. Cl. 705/14; 707/3; 707/E17.014

(57) ABSTRACT

Advertising slots on a search engine results page may be determined based on keywords and/or results to a user query. Advertisers may use the keywords and/or the results to the query to place their ads into the advertising slots. Rules may be applied to determine how ads are displayed or not displayed. For example, a larger set of keywords may be inferred from the initial set of keywords on which the ad provider placed her bids. This greatly increases the potential reach of an advertiser's ad campaign or a search engine provider's revenue from ad placement.

### BACKGROUND

As the Internet has grown, online advertising has become a popular method by which advertisers may reach consumers. For example, search engines sell ad slots on search engines to advertisers. These advertisements are typically much more targeted than print-media or TV advertising because the user performing the search indicates a current interest via a query consisting of a few keywords. The search engine may target an ad based on the user's current interest usually expressed by the keywords in the query and sometimes the history of keywords issued by the user. A similar phenomenon occurs in other online advertising, where the user conveys her intent by visiting a page or a sequence of pages related to a particular subject. For example, a user entering the query “digital camera” in the search box of a search engine, or a user reading a webpage consisting of reviews for digital cameras, is likely to be interested in digital cameras, and hence is more receptive to advertisements for digital cameras than a person flipping through the pages of the newspaper. Thus, a retailer selling digital cameras would like to bid for the query term “digital camera” so that the retailer's ad is shown for this query.

Frequently, however, the query terms that users employ to search for the same information are very diverse. A user looking for a digital camera may type the words “5 megapixel camera” or “digital SLR” or “Coolpix S10” into the search box, for example. In a system where the advertisers bid on query terms, an advertiser needs to predict what query terms are employed by a user interested in their product. Given that the distribution of queries is “heavy-tailed,” i.e., a large fraction of the queries made on a search engine are made by very few users (in other words, there are a large number of unique queries or keywords in the tail), it is difficult for the advertiser to predict all of the possible terms and place an individual bid on them. This leads to inefficiency when users looking for something using an uncommon query do not get advertisements that they may want to see, advertisers do not reach their potential customers, and the search engine loses revenue.

### SUMMARY

Advertising slots on a search engine results page may be determined based on keywords and/or results to a user query. Advertisers may use the keywords and/or the results to the query to place their ads into the advertising slots. Rules may be applied to determine how ads are displayed or not displayed. For example, a larger set of keywords may be inferred from the initial set of keywords on which the ad provider placed her bids. This greatly increases the potential reach of an advertiser's ad campaign or a search engine provider's revenue from ad placement. In an implementation, there may be provided rule-based bidding for ad placement based on query keywords and search results associated with the query keywords. Thus, if the keywords and the associated results do not satisfy any of the rules specified by the ad provider, then she would not enter into an auction to display ads for the keywords. In one implementation, auction bids may be received from advertisers based on the relative positions of the search results. The auction bids may be assigned to bid positions according to the rule-based bidding and auction bids, and the content items placed on a results page in the order of final bids entered into the auction.

In another implementation, auction bids may be received from advertisers for content item placement based on query keywords and search results associated with the query keywords. Rules may be applied for the content item placement based on results satisfying a query to determine the content item placement according to the auction bids. A results page may display the content item placement. For example, if the results contain a set of pages very similar to the ad provider's page, then the ad provider may choose to not participate in the auction for displaying ads for the given query.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is a block diagram of an example online environment;

FIG. 2 is an example content page and advertisements associated with bid placement;

FIG. 3 is a flow diagram of an example process for presenting advertising in a content page

FIG. 4 is a flow diagram of an example process for defining and applying rules to query results; and

FIG. 5 shows an exemplary computing environment.

### DETAILED DESCRIPTION

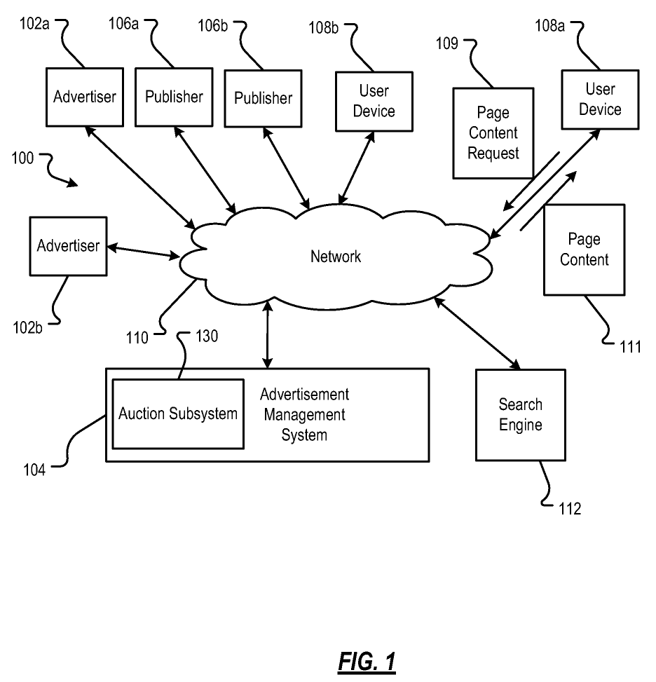

FIG. 1 is a block diagram of an example online environment 100. The online environment 100 may facilitate the identification and serving of content items, e.g., web pages, advertisements, etc., to users. A computer network 110, such as a local area network (LAN), wide area network (WAN), the Internet, or a combination thereof, connects advertisers 102a and 102b, an advertisement management system 104, publishers 106a and 106b, user devices 108a and 108b, and a search engine 112. Although only two advertisers (102a and 102b), two publishers (106a and 106b), and two user devices (108a and 108b) are shown, the online environment 100 may include many thousands of advertisers, publishers, and user devices.

In some implementations, one or more advertisers 102a and/or 102b may directly or indirectly enter, maintain, and track advertisement information in the advertising management system 104. The advertisements may be in the form of graphical advertisements, such as banner advertisements, text only advertisements, image advertisements, audio advertisements, video advertisements, advertisements combining one of more of any of such components, etc., or any other type of electronic advertisement document.

A user device, such as user device 108a, may submit a page content request 109 to a publisher or the search engine 112. In some implementations, the page content 111 may be provided to the user device 108a in response to the request 109. The page content may include advertisements provided by the advertisement management system 104. Example user devices 108 include personal computers (PCs), mobile communication devices, television set-top boxes, etc.

Advertisements may also be provided from the publishers 106. For example, one or more publishers 106a and/or 106b may submit advertisement requests for one or more advertisements to the system 104. The system 104 responds by sending the advertisements to the requesting publisher 106a or 106b for placement on one or more of the publisher's web properties (e.g., websites and other network-distributed content).

Advertisements may also be provided through the use of the search engine 112. The search engine 112 may receive queries for search results. In response, the search engine 112 may retrieve relevant search results from an index of documents (e.g., from an index of web pages). Search results may include, for example, lists of web page titles, snippets of text extracted from those web pages, and hypertext links to those web pages, and may be grouped into a predetermined number of (e.g., ten) search results.

The search engine 112 may also submit a request for advertisements to the system 104. The request may include a number of advertisements desired. This number may depend on the search results, the amount of screen or page space occupied by the search results, the size and shape of the advertisements, etc. The request for advertisements may also include the query (as entered or parsed), information based on the query (such as geo-location information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores may be computed from, for example, dot products of feature vectors corresponding to a query and a document, page rank scores, and/or combinations of IR scores and page rank scores, etc.

The search engine 112 may combine the search results with one or more of the advertisements provided by the system 104. This combined information may then be forwarded to the user device 108 that requested the content as the page content 111. The search results may be maintained as distinct from the advertisements, so as not to confuse the user between paid advertisements and presumably neutral search results.

The advertisers 102, user devices 108, and/or the search engine 112 may also provide usage information to the advertisement management system 104. This usage information may include measured or observed user behavior related to advertisements that have been served, such as, for example, whether or not a conversion or a selection related to an advertisement has occurred.

In addition to the advertisements being selected based on content such as a search query or web page content of a publisher, the advertisements may also be selected from an auction. The advertisement management system 104 may include an auction subsystem 130. The advertisers 102 may be permitted to select or bid an amount the advertisers are willing to pay for each click of an advertisement, e.g., a cost-per-click amount an advertiser pays when, for example, a user clicks on an advertisement. The cost-per-click can include a maximum cost-per-click, e.g., the maximum amount the advertiser is willing to pay for each click of advertisement based on a keyword.

For example, advertisers A, B, and C all select, or bid, a maximum cost-per-click of $0.50, $0.75, and $1.00, respectively. The maximum amount advertiser A will pay for a click is $0.50, the maximum amount advertiser B will pay is $1.00, and the maximum amount advertiser C will pay is $0.75. As such, ads associated with advertiser B will be placed higher in the ad slots than advertiser C or A.

In some implementations, the auction subsystem 130 may determine the position that each bid will occupy based on the results. The auction subsystem 130 may select the top k bids to occupy the bid positions, where k is, for example, the number of advertisement positions available on a webpage. Thus, ads may be placed based on the bid amounts.

In other implementations, rules may be applied against query keywords or the query results to determine the ads to be placed in the advertising positions or to determine the final positions of the ads relative to the available advertising slots based on the advertiser bids. Thus, an advertiser may specify a rule such that “if the keyword is X, and if the results are Y, then I want to bid so much for the keywords associated with the results I am interested in.” For example, an advertiser may be interested in results that include “Canon 850” when a user enters a query containing the keywords “digital camera.” When the “Canon 850” is included in the results, the advertiser may wish to be ranked number one in the listing of ads on the query results page. The advertiser may pay a higher bid amount for the number one ranking as part of specifying the rule. Of course, there is no guarantee that the ad provider always gets her ad to be placed in the desired position. This is because there could be another provider who has similar constraints and placed a higher (winning) bid.

In other implementations, the advertiser may specify that the advertiser's bid for ad placement is not to be included in the auction for ad space/placement unless certain query terms and/or certain results exist. For example, if “digital camera” is in the query, and “Nikon” is in the result, the advertiser will pay 50 cents per click, otherwise the advertiser does not want their ad placed.

In some implementations, the advertiser may desire to have an ad placed more prominently with respect to certain competitors. Thus, if the results page has “Nikon,” the advertiser may pay to have ads placed ahead of Nikon Corp. on the advertisers' pane and thus bid higher on the auction for the query keywords.

In some implementations, an advertiser may specify that their ad is not shown based on aspects of the results and/or query search terms. For example, a rule may be specified such as “do not show an ad if any of the results are scandalous.” Thus, an advertiser may specify where ads are placed, or not, based on the results sets. Another scenario is when the search results are already ‘rich’ enough to satisfy the user's request that the user is unlikely to click on any ad. In such a case, the ad provider might choose to either stay out of the auction or bid a very low price.

In other implementations, an advertiser may bid on a particular sequence of keywords. If a user enters “Nikon digital SLR camera,” the advertiser may bid to place an ad on the results page that satisfies the query. However, if the user enters “Canon digital SLR camera,” the advertiser's ad may not be placed on the results page in accordance with a rule.

In the other implementations, two queries may be tagged as similar if they share a lot documents on which people clicked. Thus, if the ad provider bid on keywords belonging to one of the queries, the keywords from all related queries will also be presented as alternatives to the ad provider.

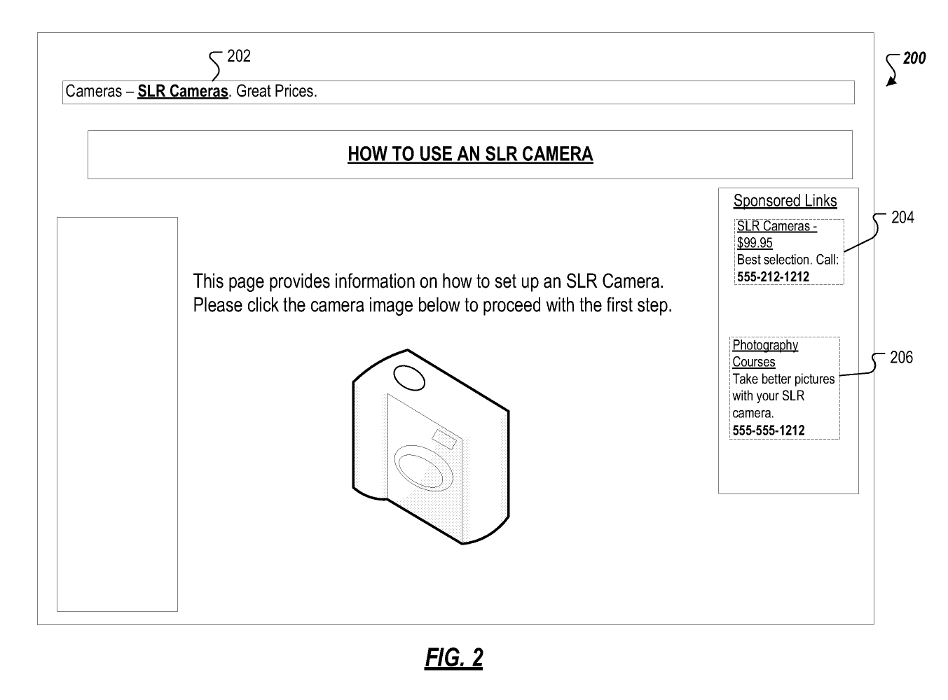

FIG. 2 is an example screen shot depicting a content page 200 containing one or more advertisements 202, 204, 206. Some of the advertisements, e.g., 202, may be slots that are not associated with a keyword bidding process, whereas other advertisements 204, 206 may be slots associated with a keywords bid upon by advertisers. Thus, if a user entered a query “SLR digital cameras” advertisement 204 may be associated with a first advertiser that has bid on keywords “cameras.” Advertisement 206 is associated with a second advertiser that has bid more generally on keywords “digital cameras.” The relative ranking may be based on the bid amount the first advertiser and the second advertiser placed for their respective keywords, or rules applied to the ad placement, as described herein.

Although only three advertisements, 202, 204, 206 are shown in FIG. 2, additional advertisements could also be presented on the content page. Additionally, while the advertisements shown in FIG. 2 are in text advertisements, other advertisement types could also be used, e.g., an advertisement with graphics, banner ads, audio ads, video ads, etc.

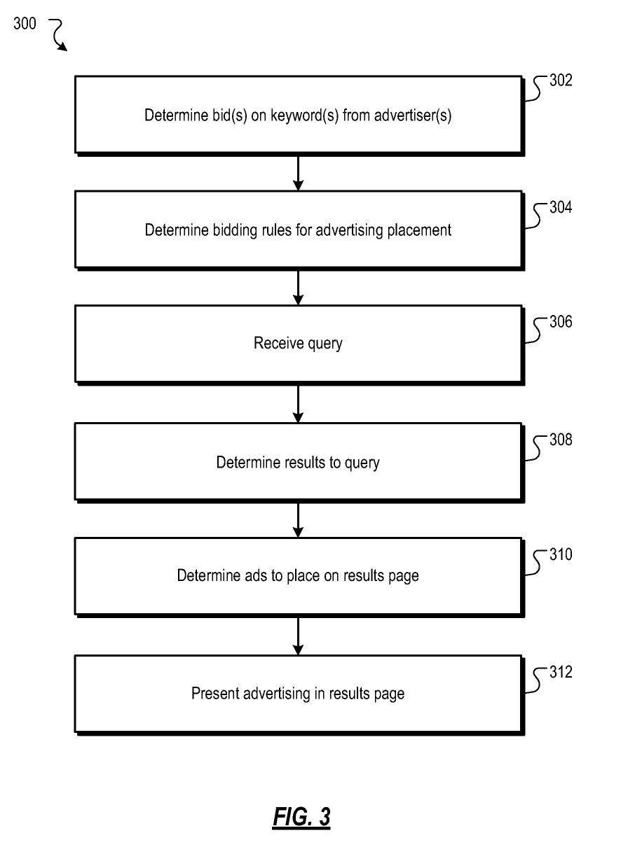

FIG. 3 is a flow diagram of an example process 300 for presenting advertising in a results page. The process 300 may, for example, be implemented in the advertisement management system 104 of FIG. 1, or in some other hardware and software computing device.

At 302, bids from an advertiser for one or more keywords are determined. For example, advertisers may bid specific amounts on keywords in order to place ads into advertising slots on a results page. The auction subsystem 130 may determine which ads are to be placed in a results page based on the bids placed by the advertisers.

At 304, rules may be determined for placing advertising. For example, the auction subsystem 130 may take into account rules that specify how advertisers would like their ads placed, or not, in the results page.

At 306, a query is received. The search engine 112 may receive a query from a user containing one or more keywords. At 308, results satisfying the query are determined. The search engine 112 may search a database of information to determine a result set that satisfies the query using any known ranking algorithm.

At 310, it is determined what ads are to be placed on the results page. The auction subsystem 130 may analyze the advertiser bids on keyword(s) and rules with respect to the query terms and/or results to determine which advertiser ads will be placed on the results page, as noted above. At 312, the advertisements in the results page are presented. The results page may be communicated by the search engine 112 as the page content 111 to the user device 108a or 108b for display in e.g., a web browser.

While the advertisements described are directed to online advertisements, the methods and systems may be used for advertisements outside of an online context. For example, the advertisements may be placed on billboards, in magazines, books, video games, and may be tracked in the same manner as described above. The advertisements may also be audio advertisements such as advertisements on the radio.

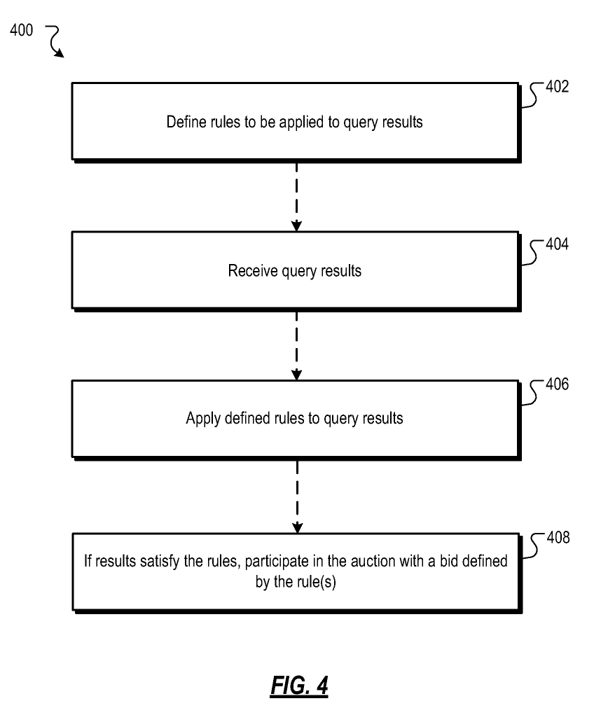

FIG. 4 is a flow diagram of an example process 400 for defining and applying rules to query results. At 402, rules are defined to be applied to query results. These rules may be defined on a per advertiser basis, on a domain name basis, or on an IP-block basis for the query results obtained. The rules may determine the ads to be placed in the advertising positions or may determine the final positions of the ads relative to the available advertising slots based on the advertiser bids, and include but are not limited to:
1. A rule to specify if the keyword is X, and if the results are Y, then bid Z for the keywords associated with the results.
2. A rule to specify that the advertiser's bid for ad placement is not to be included in the auction for ad space/placement unless certain query terms and/or certain results exist.
3. A rule to have an ad placed more prominently with respect to certain competitors.
4. A rule to specify that an ad is not to be shown based on aspects of the results and/or query search terms.
5. A rule to bid on a particular sequence of keywords.
6. A rule to tag two queries as similar if they share a large amount of common documents selected by users.
7. A rule that specifies bid placement for inferred keywords.
8. A rule where the advertiser may specify that her bid be considered if a particular URL is in the results.
9. A rule where the advertiser may specify that her bid be considered if some page from a particular domain is in the results.
10. A rule where the advertiser may specify that her bid be considered if a particular URL is in the top k slots for some specified k.
11. A rule where the advertiser may specify that her bid be considered if some page from a particular domain is in the top k results for some specified k.
12. A rule where the advertiser may specify that her bid be considered only if a certain fraction of the top k pages contain a particular keyword at least a specified number of times, for some specified k.
13. A rule where the advertiser may specify that her bid be considered if a snippet of the top result contains a given set of terms.
14. A rule where the advertiser may specify that her bid be considered if the title of the top result contains a given set of terms.

At 402, any predicate of the ordered list or search results may be used. This predicate may depend on the URL, the domain, the title of the document, a snippet, the content of the page, etc. The advertiser may combine these predicates using Boolean operators, such as ANDs and NOTs and ORs. For example, the advertiser may specify that her bid be considered if a particular URL is in the top three positions of the results and a particular domain is not in top five results, OR if five out of the top ten pages contain a particular word (e.g., the word “Coolpix”) at least three times each.

At 404, the query results are received. This is similar to 308, and the search engine 112 may search a database of information to determine a result set that satisfies the query using any known ranking algorithm. At 406, the rules defined at 402 are applied to the query results at 404. Applying the rules determines how, e.g., advertisers will bid on ad placement related to the query results. At 408, if the results satisfy the rules, then participation in the auction is performed with a bid defined by the rule(s). Based on the results at 406, the advertiser may bid in the auction as defined by the rules. Final placement of the ads will depend on the bidding process.

Exemplary Computing Arrangement

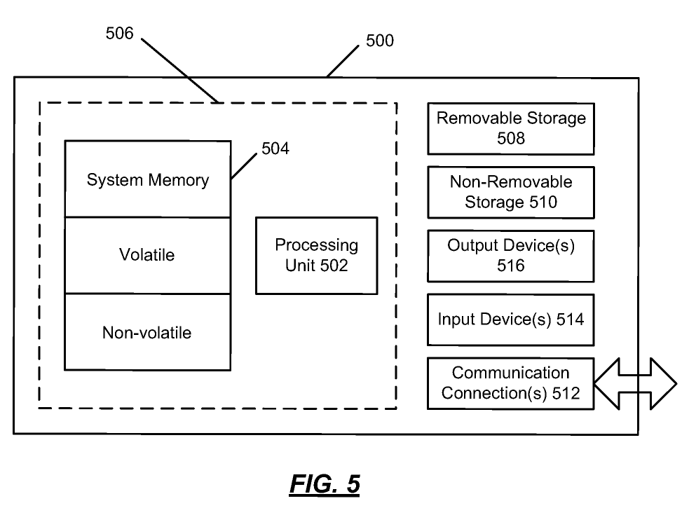

FIG. 5 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, PCs, server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media may be any available media that may be accessed by device 500 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 500. Any such computer storage media may be part of computing device 500.

Computing device 500 may contain communications connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented method, comprising:
providing rule-based bidding for ad placement based on query keywords and search results associated with the query keywords;
receiving auction bids from advertisers based on the relative positions of the search results;
assigning the auction bids to bid positions according to the rule-based bidding and auction bids; and
placing content items on a results page in accordance with the bid positions.

2. The computer-implemented method of claim 1, further comprising:
determining inferred keywords related to the query keywords; and
placing the content items on the results page based on the inferred keywords being present in a query related to a query in which the query keywords were used.

3. The computer-implemented method of claim 2, further comprising:
determining placement of the content items based on a bid price based associated with the inferred keywords.

4. The computer-implemented method of claim 2, further comprising:
determining a bid price based on a bid position of a content item placed in accordance with one of the inferred keywords.

5. The computer-implemented method of claim 1, further comprising:
defining a rule to omit at least one of the content items based on the search results.

6. The computer-implemented method of claim 1, further comprising:
defining a rule to increase a bid price associated with the content items to place the content items in a higher bid position based on the search results.

7. The computer-implemented method of claim 1, further comprising:
defining a rule to place content items associated with a first advertiser in a higher bid position than content items associated with a second advertiser based on the results of the query; and
increasing a bid price of the first advertiser.

8. The computer-implemented method of claim 1, further comprising determining a bid price based on a rule for placement of an advertiser's content item based on the search results.

9. The computer-implemented method of claim 8, further comprising determining the bid price based on an assigned bid position of the advertiser's content item as determined by the rule-based bidding.

10. A computer-implemented method, comprising:
receiving auction bids from advertisers for content item placement based on query keywords and search results associated with the query keywords;
applying rules for the content item placement based on results satisfying a query to determine the content item placement according to the auction bids; and
presenting a results page displaying the content item placement.

11. The computer-implemented method of claim 10, further comprising:
defining the rules for the content item placement based on inferred keywords associated with the query keywords and the search results associated with the inferred keywords.

12. The computer-implemented method of claim 11, further comprising:
determining a bid price based on the inferred keywords and the rules associated with placement of a content item based on the inferred keywords.

13. The computer-implemented method of claim 10, further comprising:
applying a rule to alter the content item placement of a first advertiser based on a second advertiser having a higher placement; and
increasing a bid price of the first advertiser.

14. The computer-implemented method of claim 10, further comprising:
applying a rule to forego content item placement of a first advertiser based on the search results.

15. The computer-implemented method of claim 10, further comprising:
increasing a bid of an advertiser based on a rule to alter the content item placement.

16. A computer-readable medium having a computer program stored thereon, the computer program comprising computer-executable instructions for performing the computer-implemented steps of:
providing rule-based bidding for ad placement based on query keywords and search results associated with the query keywords;
receiving auction bids from advertisers based on the relative positions of the search results as provided by a search engine;
assigning the auction bids to bid positions according to the rule-based bidding and auction bids; and
placing content items on a results page in accordance with the bid positions.

17. The computer-readable medium of claim 16, further comprising instructions for:
determining inferred keywords related to the query keywords; and
placing content items on the results page based on the inferred keywords being present in a query related to a query in which the query keywords were used.

18. The computer-readable medium of claim 16, further comprising instructions for:
defining a rule to place the content items in a higher bid position based on the search results.

19. The computer-readable medium of claim 16, further comprising instructions for:
defining a rule to place the content items associated with a first advertiser in a higher bid position than content items associated with a second advertiser based on the search results; and
increasing a bid price of the first advertiser.

20. The computer-readable medium of claim 16, further comprising instructions for:
omitting content items of a first advertiser based on the search results.
